(19) United States
(12) Patent Application Publication
(10) Pub. No.: US 2002/0193710 A1
(43) Pub. Date: Dec. 19, 2002

(54) Leg stretching apparatus

(76) Inventors: Ian Main, Calgary, CA (US); Roy H. Schneider, Belleville, IL (US); Deborah J. Schneider, Belleville, IL (US)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/063,683

(22) Filed: May 8, 2002

(30) Foreign Application Priority Data
May 9, 2001 (CA) 2,346,758

(51) Int. Cl. A61H 1/02

(52) U.S. Cl. 601/5; 601/34

(57) ABSTRACT

The invention provides for an apparatus for performing physiotherapy, in particular, it provides an apparatus for stretching the hind leg muscles in isolation from the other muscle groups. In accordance with the invention, the apparatus comprises a seat and backrest mounted to a base. Further, a moveable swing arm with a heel pad at the end is pivotally attached to the base. The swing arm is actuated by actuation means such that the heel pad moves in an arc. In use the user sits on the seat and places their heel on the heel pad. In the initial position the user's leg is bent. The swing arm is then moved to a position whereby the users leg is substantially straight. The leg is held in the straightened position for a period and then is returned to the bent position. The actuation means can be a manually operated hydraulic pump.

CROSS REFERENCE TO RELATED APPLICATIONS

This application claims the benefit of Canadian Application No. 2,346,758 filed on May 9, 2001.

### BACKGROUND OF INVENTION

The present invention relates to an apparatus for performing physiotherapy. In particular, it relates to an apparatus for stretching the hind muscles of the upper leg.

In performing physical therapy to recover from an injury or enhance athletic performance, it is desirable to stretch certain muscle groups in isolation. Various stretching exercises are well known but must be performed with correct technique in order to be effective. If done incorrectly, the patient or athlete may suffer injury or may not achieve the benefit of the stretching exercise.

Therefore, there is a need in the art for a stretching apparatus which allows for the stretching of the hamstring muscles in isolation and with correct technique.

### SUMMARY OF INVENTION

The present invention is directed to an apparatus for stretching various hind muscles of the leg in isolation of the other muscle groups.

Accordingly, in one aspect, the invention comprises an apparatus comprising:

(a)a seat having a seat pad for supporting an upper leg of the user and a backrest, said seat mounted to a base;

(b)a heel pad for supporting a lower leg of the user wherein said heel pad is pivotally attached to the base and movable from a first position wherein the user leg is bent at the knee through an arch to a second position where the user leg is straighter than in the first position;

(c)actuating means for moving the member from the first position to the second position.

In one embodiment, the heel pad is pivotally attached to the base by means of a swing arm and the actuating means may comprise a hydraulic cylinder. In another embodiment, the apparatus further comprises a means for restraining the upper leg of a user and comprises numerous features that are provided to provide ergonomic comfort to the user and that assist in positioning the user's body to ensure correct stretching technique. The backrest may be slidably mounted to the seat or the base permitting the adjustment of its proximity to the seat and to the angle of its tilt. The backrest may also have an adjustable lumbar support which when appropriately positioned, ensures that a proper lordotic curve is maintained throughout the stretching process. In one final embodiment, an angular slant board is attached to the base in a position posterior to the backrest as an alternative muscle stretching mechanism for the gastrocnemius muscle .

### BRIEF DESCRIPTION OF DRAWINGS

The invention will now be described by way of an exemplary embodiment with reference to the accompanying simplified, diagrammatic, not-to-scale drawings. In the drawings:

FIG. 1 is a perspective view of one embodiment of the invention.

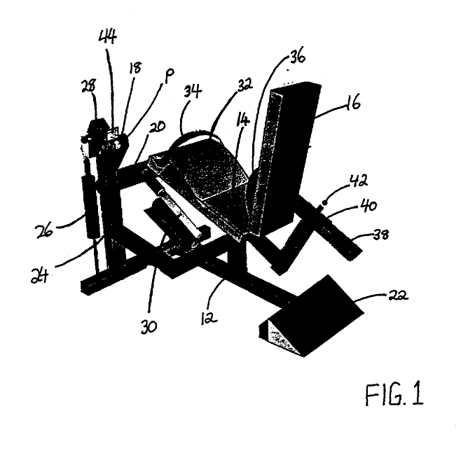

FIG. 2 is a side view of one embodiment of the invention.

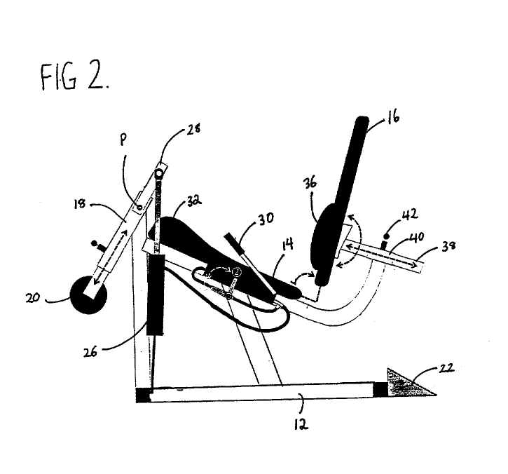

FIG. 3 is a side view showing an embodiment of the invention in the initial position.

FIG. 4 is a side view showing an embodiment of the invention in the stretched position.

FIG. 5 shows a gauge of one embodiment of the invention.

FIG. 6 is a side view of an embodiment of the invention showing use of the slant board.

### DETAILED DESCRIPTION

The present invention provides for a hamstring stretching apparatus. When describing the present invention, the following terms have the following meanings, unless indicated otherwise. All terms not defined herein have their common art-recognized meanings. As used herein, the term “hamstring muscles” shall refer to the muscles located at the back of the upper leg, the upper leg being that portion of the leg between the knee and the waist.

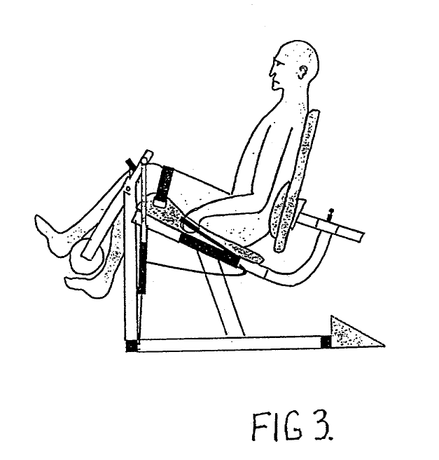

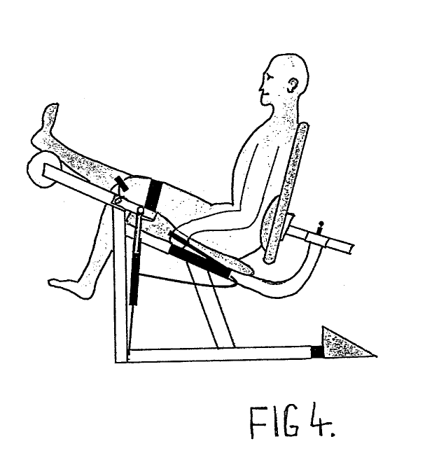

In general terms, the apparatus (10) comprises a base (12), a seat (14) mounted to said base (12) and which includes a backrest (16) and a moveable swing arm (18) having a heel pad (20) at one end. The swing arm (18) is pivotally attached to the base (12). The swing arm (18) is actuated by actuation means such that the heel pad (20) moves in an arc. In use, a user sits on the seat and rests his or her feet on the heel pad (20). The heel pad (20) and swing arm (18) start in an initial position where the user's leg is bent at approximately 90° as is illustrated in FIG. 3. The heel pad (20) and swing arm (18) may then be moved towards a position where the user's leg is substantially straight as illustrated in FIG. 4.

In one embodiment, as illustrated in the Figures, the base (12) comprises an assembly of square tubing which supports the remaining elements of the machine. The seat (14) and backrest (16) are mounted to the base such that a user is supported in a comfortable position.

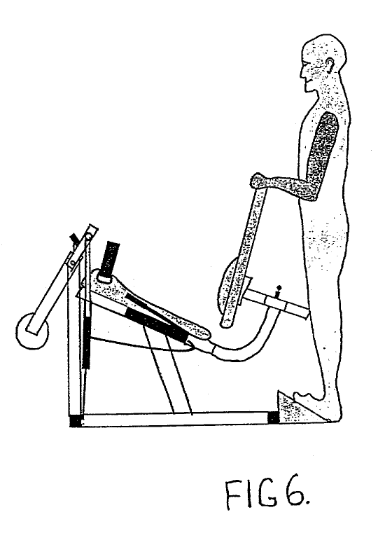

In a preferred embodiment, an angular slant board (22) is attached to the base (12) at ground level in any suitable position, one suitable position is posterior to the backrest (16) as shown in FIG. 6. The slant board (22) provides an alternative muscle stretch mechanism for the gastrocnemius or calf muscle. To utilize the slant board (22), the user places the entire surface of the foot on the slant board (22) while pointing their toes, hips and body forwards with the knee in a straight position as illustrated in FIG. 6.

The swing arm (18) is pivotally mounted to a post (24) which forms part of the base (12). The pivot point (P) is provided such that it is aligned with the knee of a user who is seated on the apparatus (10). Actuating means in the form of a hydraulic cylinder (26) is also mounted to the base (12) at one end and is attached to the swing arm (18) by means of a lever arm (28) attached to the swing arm (18) by a shaft which passes through the post and which constitutes the pivot point (P) of the swing arm (18).

The hydraulic cylinder (26) is extended by a hand pump (30) which may be situated beside the seat (14) so as to be actuated by the user. Alternatively, the hydraulic cylinder (26) may be actuated by a small electrically powered hydraulic pump and appropriate controls provided on the apparatus (10). The hand pump (30) preferably allows fine control over the movement of the swing arm (18) and therefore the degree of stretch desired.

In a preferred embodiment, numerous features are provided to provide ergonomic comfort to the user and assist in positioning the user's body to ensure correct stretching technique. A preferred embodiment may include all, some or none of these features.

A small bulge (32) in the seatpad towards the front edge of the seat (14) assists in keeping the user from rising up off the seat (14). A thigh stabilizing strap (34) is provided to strap the users thigh to the seat (14).

A lumbar support (36) is provided on the backrest (16) to keep the user's spine in an aligned position. The lumbar support (36) may be adjustable vertically along the backrest (16). The lumbar support (36) puts the pelvis into a slight anterior tilt which stabilizes the insertion point of the hamstring muscle. This ensures that a proper lordotic curve is maintained throughout the stretching process.

The backrest (16) may be slidably mounted to the seat (14) or the base (12) to adjust the distance between the seat (14) and the backrest (16). In the embodiment illustrated, the backrest (16) is mounted to a square tube (38) which slides within a sleeve (40) to adjust the distance. It is secured by a pin (42) which engages one of a plurality of holes in the square tube (38) through the sleeve (40).

The tilt of the backrest (16) is adjustable by altering the angle between the backrest (16) and the square tube (38). This alters the degree of hip flexion of the user. The hips should be flexed at an angle of about 60° to stabilize the hamstring muscle at the hip and to remove any slack in the hamstring muscle before the stretching process begins.

The heel pad (20) is slidably adjustable on the swing arm (18) to adjust for different lengths of user's lower legs. The heel pad (20) should be positioned such that the user's Achilles tendon rests on the heel pad (20).

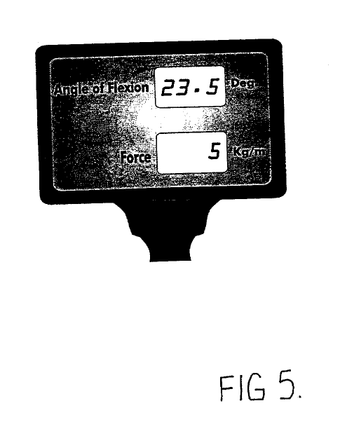

In a preferred embodiment, a gauge (44) which measures and displays the angle of the swing arm (18) and the force applied to the heel pad (20) may be provided to give the user feedback. The gauge (44) may be useful to track progress of the user from session to session. The gauge (44) may measure the angle in degrees, as is shown in FIG. 5, in a percentage value or some other measure. The gauge may measure the force or pressure applied to the heel pad in kilograms per meter. The gauge may be a needle on a dial or a digital readout or some other human readable display, which are well known in the art.

In use, a user seats himself or herself in the apparatus (10) and adjusts the backrest tilt and distance, the heel pad position and lumbar support position as desired. Preferably, the hips are angled at about 60° of flexion, although this angle may be adjusted to suit the user. Adequate hip flexion stabilizes the hamstring at the hip, thereby removing any hamstring muscle slack. The user may stretch one leg at a time, or may place both legs on the heel pad (20) to stretch both legs at one time. The thigh stabilizing strap (34) is secured and the user may begin to actuate the hydraulic cylinder (26) with the hand lever pump (36). As described above, this action will raise the swing arm (18) and heel pad (20), causing the user's legs to straighten. The user may gauge (44) the extent of stretch using the gauge (44) and when the maximum stretch position is reached, the user should hold that position for a period of time which may be about 30 seconds. When finished, the user may release the hydraulic cylinder (26) and allow the heel pad (20) and swing arm (18) to lower to the start position.

As will be apparent to those skilled in the art, various modifications, adaptations and variations of the foregoing specific disclosure can be made without departing from the scope of the invention claimed herein.

1. A leg stretching apparatus for stretching the hamstring muscles of a human user, said apparatus comprising:
(a)a seat having a seatpad for supporting an upper leg of the user and a backrest, said seat mounted to a base;
(b)a heel pad for supporting a lower leg of the user wherein said heel pad is pivotally attached to the base and moveable from a first position wherein the user leg is bent at the knee through an arc to a second position where the user leg is straighter than in the first position;
(c)actuating means for moving the member from the first position to the second position.

2. The apparatus of claim 1 further comprising means for restraining the upper leg of a user.

3. The apparatus of claim 1 further comprising means to adjust the angle between seatpad and the backrest.

4. The apparatus of claim 1 further comprising means to adjust the lateral position of the backrest.

5. The apparatus of claim 4 wherein the backrest lateral adjustment means comprises a square tube mounted to the backrest, said square tube sliding within a sleeve and being secured by a pin which engages one of a plurality of holes in the square tube and sleeve.

6. The apparatus of claim 1 wherein the backrest comprises a lumbar support.

7. The apparatus of claim 5 wherein the lumbar support is adjustable vertically.

8. The apparatus of claim 1 wherein the actuating means comprises a hydraulic cylinder.

9. The apparatus of claim 1 further comprising a gauge for measuring the position of the heel pad along its arc.

10. The apparatus of claim 1 further comprising a gauge for measuring the force or pressure applied to the heel pad.

11. The apparatus of claim 1 further comprising a slant board attached to the base in position posterior to said backrest.

12. A hamstring stretching machine comprising:
(a)a base adapted to supporting a user in a seated position, said base comprising a seat for supporting the upper leg of the user and a backrest;
(b)a swing arm having a first end and a second end wherein the first end is pivotally attached to the base;
(c)a heel pad associated with the second end of the swing arm for supporting the lower leg of a user;
(d)means for actuating the swing arm to pivot around its first end such that the heel pad travels in a generally arcuate path thereby straightening the leg of the user.

13. The apparatus of claim 12 wherein the actuating means comprises a hydraulic cylinder.
